(19) United States
(12) Patent Application Publication
(10) Pub. No.: US 2010/0003505 A1
(43) Pub. Date: Jan. 7, 2010

(54) WATERPROOF SHEET

(76) Inventors: Chan-Oh Yoon, Chungcheongbuk-do (KR); Jong-Cheol Lee, Chungcheongbuk-do (KR); Hyung-Min Cha, Chungcheongbuk-do (KR)

Correspondence Address: LGCHEM;Lerner, David, Littenberg, Krumholz & Mentlik, LLP, 600 South Avenue West, Westfield, NJ, 07090, US

(21) Appl. No.: 12/310,154

(22) PCT Filed: Dec. 27, 2006
(86) PCT No.: PCT/KR2006/005733

§ 371 Date: Feb. 11, 2009

(30) Foreign Application Priority Data
Aug. 11, 2006 (KR) 10-2006-0075962

(51) Int. Cl. B32B 27/36; B32B 23/00; B32B 27/34; B32B 27/40; B32B 27/32; B32B 27/38

(52) U.S. Cl. 428/335; 428/480; 428/532; 428/474.4; 428/423.1; 428/523; 428/339; 428/413; 428/421; 428/521; 428/334

(57) ABSTRACT

Disclosed herein is a waterproof sheet. More specifically, disclosed herein is a waterproof sheet with improved water resistance, airtightness and durability by which the waterproof sheet is produced by adhering a polyvinylchloride (PVC) alloy sheet as an plastic sheet to the at least one surface of a polyester film as an intermediate.

### TECHNICAL FIELD

The present invention relates to a waterproof sheet. More specifically, the present invention relates to a reusable waterproof sheet with improved water resistance, airtightness and durability.

### BACKGROUND ART

Waterproof sheets impart water leakage prevention/waterproof systems to a variety of industrial facilities including agriculture, civil engineering, construction and leisure facilities, etc. Waterproof sheets are used in a variety of applications including: dam, river and reservoir banks; prevention systems of reservoir damage; sewage, water tanks, wastewater tanks, pools and wastewater utilities; and environmental protection facilities.

Continuous increase in water resource, environment and construction projects has brought about an increase in demands for water leakage prevention/waterproof systems. Such a great demand for systems accelerates product development. As a result, waterproof sheets are being utilized in extruded plastic products and calendar sheets made of a material selected from polyvinyl chloride (PVC), polyethylene (PE), high-density polyethylene (HDPE), low-density polyethylene (LDPE), etc.

With a continually increasing demands for products associated with railroads, roads and environmental protections, there has been an increased need for not only sheet products, but reinforced coated fabric products in which a polyester or nylon fabric is combined with one selected from polyvinyl chloride (PVC), polyethylene (PE), high-density polyethylene (HDPE), low-density polyethylene (LDPE), polypropylene (PP), thermoplastic olefin (TPO) elastomer and thermoplastic urethane (TPU) elastomer.

More particularly, rather than a single-material sheet, in an attempt to improve effective value, there may be used a blend or alloy sheet which is upgraded to premium grade by modifying inherent characteristics of the material via filling of an unusual reinforcement. In addition, to lower water and gas permeability, the alloy sheet may be adhered to the both sides of a fabric. In general, the sheet is surface-coated, thus undergoing reinforcement. (U.S. Pat. No. 5,346,755, entitled “Stain resistant cleanable PVC fabric”)

Conventional sheet products have limitations in water resistance and airtightness due to their medium fabric structures. To overcome these limitations and prevent the surface contamination, surface treatment is further performed.

JP Patent No. 3,544,927 discloses a waterproof sheet consisting of a top layer, a under layer, and an intermediate layer interposed between the top layer and the under layer, wherein the top layer is made of a synthetic resin, and the intermediate layer is made of a non-waven fabric. In order that a shield layer for preventing the transfer of a plasticizer, which does not contain the resin constituting the top and under layers, is disposed inside the intermediate layer, the both surfaces of the non-waven fabric having a base weight of 80 to 200 g/m² and a thickness of 0.3 to 1.5 mm are impregnated with 100 to 250 g/m² of a polyvinylchloride resin paste sol. The use of the non-waven fabric involves limitations of water resistance and airtightness.

Japanese Patent Laid-open Publication No. 2001-58379 discloses an outdoor waterproof sheet comprising a plurality of a first laminate bonded by a usual adhesive agent. The first laminate consists of at least two layers, i.e., a surface layer and a rear layer wherein the surface layer is made of one selected from acrylic, fluoroplastic, olefinic and urethane resins, and the rear layer is made of a vinyl chloride resin and comprises 40% or less by weight of a plasticizer with respect to the vinyl chloride resin. This waterproof sheet is different from the waterproof sheet of the present invention in view of material and structure.

Korean Patent No. 483,722 discloses a dual polyvinyl chloride waterproof sheet containing a recycled polyvinyl chloride waterproof sheet. The recycled polyvinyl chloride waterproof sheet consists of a recycled polyvinyl chloride sheet and a new polyvinyl chloride sheet laminated on the recycled polyvinyl chloride sheet, wherein the recycled polyvinyl chloride sheet comprises 70 to 80% by weight of a waste polyvinyl chloride resin, 10 to 14% by weight of a recycled resin obtained by recycling a waste vinyl acetate copolymer adhesive film scrap, 5 to 8% by weight of a recycled resin obtained by recycling a waste vinyl acetate copolymer adhesive, and 5 to 8% by weight of a stone powder. The recycled polyvinyl chloride sheet and the new polyvinyl chloride sheet is laminated in a thickness ratio of 5:1 to 6:1. However, this waterproof sheet is different from the waterproof sheet of the present invention in view of material and structure.

### DISCLOSURE OF THE INVENTION

### Technical Problem

Therefore, it is one object of the present invention to provide a reusable waterproof sheet with improved water resistance, airtightness and durability.

### Technical Solution

In accordance with one aspect of the present invention, there is provided a waterproof sheet for preventing water leakage comprising an airtight film and a plastic sheet laminated on at least one surface of the airtight film.

The film type employed in the present invention is thin and light-weight, as compared to conventional fabrics, thus being effective in ensuring easy handling, good processability and airtightness.

The term “airtightness” used in the present invention means that oxygen permeability measured in accordance with KS A 1512 is 200 ml/m²hr or less.

The airtight film that may be used in the present invention is selected from polyester (i.e., polyethylene terephthalate (PET)), cellulose, polyamide, polyurethane, vinyl and polyolefin films. Of these films, most preferred is a flexible polyester film which exhibits superior airtightness, is inexpensive and is most commonly used in the art. Polyester films have advantages of superior strength and flexibility, low costs, easy control of product sizes due to high surface flatness, and various product sizes according to the desired type. More particularly, it is preferable to use a polyester film whose both surfaces are treated with a primer. This is the reason that such a polyester film enables improvement in adhesion with a sheet without additional adhesion or primer treatment.

The thickness of the airtight film is 10 to 500 μm, preferably, 25 to 100 μm. The airtight film consisting of a sheet singly has limitations in mechanical properties, water resistance and airtightness. In an attempt to overcome these limitations, the airtight film may be reinforced. When the airtight film has an excessively large thickness, it undergoes considerable improvement in mechanical properties and air-tightness, but disadvantageously involves deterioration in handlability due to an increased hardness and weight. Meanwhile, when an airtight film has an excessively large thickness, it has superior handlability, but disadvantageously involves deterioration in mechanical properties and airtightness.

The airtight film and the plastic sheet are adhered to each other by an adhesive or a primer. The adhesive may be melanin, epoxy, rubber, acrylic, ester, urethane, or a mixture thereof To enhance an adhesion between the airtight film and the plastic sheet and prevent revitalization by heat at a high temperature after processing, preferred is a two-component adhesive. Unless applied under strict conditions, a one-component adhesive may be used.

The plastic sheet that may be used in the present invention is a functional plastic selected from polyvinylchloride (PVC), polyolefin such as polyethylene and polypropylene, thermoplastic polyurethane (TPU), thermoplastic polyolefin (TPO), styrene butadiene styrene (SBS) and acrylonitrile butadiene styrene (ABS); a rubber selected from acrylonitrile butadiene rubber (NBR), chloroprene rubber (CR), hypalon, natural rubber and butyl rubber (IIR); or a blend or alloy thereof. A polyvinylchloride (PVC) alloy sheet is particularly preferred.

The PVC alloy sheet is produced by mixing a PVC resin with reinforcing material. There may be used ABS, NBR and the like as an alloy component to modify the PVC resin.

The PVC alloy sheet may comprise at least one additive selected from inorganic fillers, i.e., calcium carbonate, organic or inorganic pigments (diluents), thermal stabilizers, ultraviolet (UV) stabilizers, flame retardants and antistatic agents.

The PVC alloy sheet may preferably comprise a high molecular weight plasticizer, rather than plasticizers commonly known in the art selected from dioctyl phthalate (DOP), diisodecyl phthalate (DIDP) and diisononyl phthalate (DINP). The use of the high molecular weight plasticizer prevents plasticizer migration, thereby causing an improvement in durability and prevention of environmental contamination.

As preferred polymeric plasticizers, there may be used an ethylene plasticizer having a high molecular weight of 10,000 to 500,000 and a good compatibility with the PVC resin. The high molecular weight plasticizer is preferably used in an amount of 10 to 150 phr. As used herein, the “phr” indicates “parts per hundred resin”.

The use of the high molecular weight plasticizer in an excessively small amount causes an increase in the content of the low molecular weight plasticizer. As a result, migration of the low molecular weight plasticizer is occurred. Meanwhile, the use of the high molecular weight plasticizer in an excessively large amount causes deterioration in processability, and makes it difficult to maintain inherent characteristics of PVC. Accordingly, it is preferable to use the high molecular weight plasticizer within the range defined above.

Preferably, the thickness of the PVC alloy sheet is 50 to 2,000 μm. The PVC alloy sheet having an excessively small thickness cause deterioration in processability and abrasion resistance. Meanwhile, the PVC alloy sheet having an excessively large thickness causes deterioration in processability and workability.

The waterproof sheet of the present invention is produced by coating an adhesive binder on a highly airtight film and bonding a plastic sheet on the at least one surface of the film.

According to the present invention, the highly airtight polyester film is used rather than conventional fabrics, and the plastic sheet is adhered to the both surfaces of the film. The resulting sheet has improved water resistance and airtightness, thereby eliminating the necessity of performing any additional surface treatment. In addition, the sheet has a relatively small thickness and is lightweight, thus realizing good workability.

To eliminate conventional sheet products, incineration must be used due to their fabric structures. On the other hand, the airtight film (i.e., the polyester film) and the plastic sheet (i.e., the PVC alloy sheet) used in the present invention are thermoplastic, and they are advantageously recycled by heating.

The waterproof sheets according to the present invention are functional products that can be used in a variety of applications including: systems for preventing damage to dam, river and reservoir banks; sewage, water tanks, wastewater tanks, pools and wastewater utilities; environmental protection facilities; and roof or rooftop finishing materials of structures.

Best Mode

The present invention will be better understood from the following examples. These examples are not to be construed as limiting the scope of the invention. Well-known or apparent contents to those skilled in the art will be omitted or briefed.

### EXAMPLES

### Example 1

A PET film (available from SKC Co., Ltd, Grade SH 22, film having both surfaces treated with a primer, and a thickness of 100 μm) was used as an airtight film. A mixture consisting of 90% by weight of an ester adhesive and 10% by weight of an isocyanate hardner and being adjusted to a viscosity of 2,000 cps was used as an adhesive.

A PVC alloy sheet with a thickness of 300 μm as a plastic sheet was adhered to the both surfaces of the PET film to produce a waterproof sheet. The PVC film used herein was obtained by mixing 100 phr of a PVC resin (LS100® available from LG Chem. Ltd.), 50 phr of a high molecular weight plasticizer (Elvaloy 741® available from Dupont), 50 phr of a high molecular weight plasticizer (DOP® available from LG Chem. Ltd.) and 10 phr of filler.

### Example 2

A waterproof sheet was produced in the same manner as in Example 1, except that a nylon 6 film having a thickness of 15 μm (available from Toyobo Co., Ltd., Japan, packing grade) was used as an airtight film.

### COMPARATIVE EXAMPLE

A waterproof sheet was produced in the same manner as in Example 1, except that a plain weave (denier: 1,000) was used as a polyester fabric instead of the polyester film.

### TEST EXAMPLE

Table 1 shows test results for waterproof functionality and airtightness of waterproof sheets each produced in Examples and Comparative Examples. The waterproof functionality was evaluated by measuring a hydrostatic resistance. The airtightness was evaluated by measuring gas permeability.

As can be seen from Table 1, waterproof sheets produced by using the film type in accordance with Examples exhibited superior waterproof functionality and airtightness, as compared to that produced by using the fabric type in accordance with Comparative Example.

TABLE 1

| | Example 1 | Example 2 | Comparative Example |
|---|---|---|---|
| Waterproof | excellent | excellent | average |
| functionality | | | |
| Airtightness | excellent | excellent | average |

The hydrostatic resistance for the waterproof functionality test was measured in accordance with ASTM D751 Procedure A. When the measured value is 6 MPa or more, it was evaluated as “excellent”. Meanwhile, when the measured value is lower than 6 MPa, it was evaluated as “average”.

The gas permeability for the airtightness test was measured in accordance with KS A 1512. When the measured value is 120 ml/m²hr or more, it was evaluated as “excellent”. Meanwhile, when the measured value is lower than 120 ml/m²hr, it was evaluated as “average”.

### INDUSTRIAL APPLICABILITY

As apparent from the above description, conventional fabric reinforced PVC products had limitations in water resistance and airtightness. To overcome these limitations, there was a need for additional surface treatment with an acrylic resin. According to the present invention, an airtight film rather is used rather than fabrics, thereby exhibiting excellent water resistance and airtightness. The use of the airtight film eliminates the necessity of performing additional surface treatment, thereby realizing simplified procedure. In addition, since the airtight film and a plastic sheet are thermoplastic, they can be advantageously recycled by heat. The plastic sheet comprises a high molecular weight plasticizer, thus causing an improvement in durability due to prevention of plasticizer migration and preventing environmental contamination.

1. A waterproof sheet for preventing water leakage comprising an airtight film and a plastic sheet laminated on at least one surface of the airtight film.

2. The waterproof sheet for preventing water leakage according to claim 1, wherein the airtight film comprises at least one selected from polyester films, cellulose films, polyamide films, polyurethane films, vinyl films and polyolefin films.

3. The waterproof sheet for preventing water leakage according to claim 1, wherein the airtight film is a polyester film having both surfaces treated with a primer.

4. The waterproof sheet for preventing water leakage according to claim 1, wherein the airtight film has a thickness of 10 to 500 μm.

5. The waterproof sheet for preventing water leakage according to claim 1, wherein the airtight film and the plastic sheet are adhered to each other by an adhesive or a primer.

6. The waterproof sheet for preventing water leakage according to claim 5, wherein the adhesive comprises at least one selected from melanin adhesives, epoxy adhesives, rubber adhesives, acrylic adhesives, ester adhesives and urethane adhesives.

7. The waterproof sheet for preventing water leakage according to claim 5, wherein the adhesive is a two-component adhesive.

8. The waterproof sheet for preventing water leakage according to claim 1, wherein the plastic sheet is polyvinylchloride (PVC), polyolefin, thermoplastic polyurethane (TPU), thermoplastic polyolefin (TPO), styrene butadiene styrene (SBS) acrylonitrile butadiene styrene (ABS), a rubber, a blend thereof or an alloy thereof.

9. The waterproof sheet for preventing water leakage according to claim 8, wherein the plastic sheet is a polyvinylchloride (PVC) alloy sheet.

10. The waterproof sheet for preventing water leakage according to claim 9, wherein the PVC alloy sheet comprises at least one additive selected from inorganic fillers, pigments, thermal stabilizers, ultraviolet stabilizers, flame retardants and antistatic agents.

11. The waterproof sheet for preventing water leakage according to claim 9, wherein the PVC alloy sheet comprises a high molecular weight plasticizer.

12. The waterproof sheet for preventing water leakage according to claim 11, wherein the high molecular weight plasticizer is an ethylene-based plasticizer.

13. The waterproof sheet for preventing water leakage according to claim 11, wherein the high molecular weight plasticizer is added in an amount of 10 to 150 phr (part per hundred resin).

14. The waterproof sheet for preventing water leakage according to claim 9, wherein the PVC alloy sheet has a thickness of 50 to 2,000 μm.

15. The waterproof sheet for preventing water leakage according to claim 1, wherein the airtight film and the plastic sheet are thermoplastic.
